(19) United States
(12) Patent Application Publication
(10) Pub. No.: US 2022/0147866 A1
(43) Pub. Date: May 12, 2022

(54) ECLECTIC CLASSIFIER AND LEVEL OF CONFIDENCE

(71) Applicant: Ko-Hui Michael FAN, Taipei City (TW)

(72) Inventors: Ko-Hui Michael FAN, Taipei City (TW); Chih-Chung CHANG, Taipei City (TW); Kuang-Hsiao-Yin KONGGUOLUO, Taipei City (TW)

(21) Appl. No.: 17/096,450

(22) Filed: Nov. 12, 2020

(51) Int. Cl. G06N 20/00

(52) U.S. Cl. CPC G06N 20/00

(57) ABSTRACT

The present invention provides an eclectic classifier including an input module, a data collection module, a classifier combination module, and an output module. The input module is configured to receive sample data. The data collection module is configured to store a collection of data from the input module. The collection of data includes a training set and/or a test set. The classifier combination module is configured to combine at least two developed classifiers trained with the training set. The output module is configured to derive an output result after the sample data is processed through the classifier combination module.

### BACKGROUND OF THE INVENTION

### 1. Field of the Invention

The present invention relates to machine learning of artificial intelligence (AI) and, more particularly, to an eclectic classifier and level of confidence thereof.

### 2. Description of Related Art

As is well known, machine learning builds a hypothetical model based on sample data for a computer to make a prediction or a decision. The hypothetical model may be implemented as a classifier, which approximates a mapping function from input variables to output variables. The goal of machine learning is to make the hypothetical model as close as possible to a target function which always gives correct answers. This goal may be achieved by training the hypothetical model with more sample data.

Machine learning approaches are commonly divided into three categories: supervised learning, unsupervised learning, and reinforcement learning. Various models have been developed for machine learning, such as convolutional neural network (CNN), recurrent neural network (RNN), long short-term memory (LSTM) network, YOLO, ResNet, ResNet-18, ResNet-34, Vgg16, GoogleNet, Lenet, MobileNet, decision trees, and support vector machine (SVM).

However, in the traditional approach, a classifier is applied with only a single model. As shown in FIG. 1, separate classifiers ŷ₁, ŷ₂, . . . , ŷₖ produce their own outputs with respect to the same input x. While, every model has its own advantages and drawbacks, in terms of accuracy, robustness, complexity, speed, dependency, cost, and so on; when a model focuses on some points, it may possibly neglect the others, and therefore an extreme bias may occur.

Therefore, it is desirable to provide an improved classifier to mitigate and/or obviate the aforementioned problems.

### SUMMARY OF THE INVENTION

In fact, the proposed invention considers several models simultaneously. It employs the results of these models and outputs a balanced answer. The invention gives an eclectic solution to the classification problem and a byproduct which we call “level of confidence”, although it takes more computation and time.

To our knowledge, there is no single classifier model (or algorithm) that solves every classification problem with the highest accuracy. Thus, according to a first aspect of the present invention, a method is provided to implement an eclectic classifier.

The eclectic classifier of the present invention may be implemented in a cloud server or a local computer as hardware or software (or computer program) or as separated circuit devices on a set of chips or an integrated circuit device on a single chip.

Before implementing the main steps of the eclectic classifier of the present invention, several preliminary steps should be performed in advance.

(Preliminary Step P1: Preparing a Training Set)

Let Ω⊂ [symbol] ^{p} be a collection of data (or observations) which is composed of m memberships (or categories) of elements, and the m memberships are digitized as 1, 2, . . . , m.

A part of data Ωₜᵣ⊂Ω, typically called a “training set” and another part of data Ωₜₜ⊂Ω, typically called a “test set” are prepared from the data Ω. The collection of data Ω may optionally include more parts, such as a remaining set Ωₜₕ.

(Preliminary Step P2: Setting a Membership Function)

Let y:Ω→S={1, 2, . . . , m} be a membership function (also regarded as a target function) so that y(x) gives precisely the membership of x.

(Preliminary Step P3: Training a Developed Classifier)

The goal of the classification problem is to use the training set Ωₜᵣ to derive a classifier ŷ(x) that serves as a good approximation of y(x).

(Preliminary Step P4: Decomposing the Training Set into Subsets)

Clearly, y(x) and ŷ(x) produce two decompositions of Ωₜᵣ as disjoint unions of subsets:

$${Ω}_{tr} = {⋃}_{h - 1}^{m} {Ω}_{tr} ( j ) = {⋃}_{j = 1}^{m} {\hat{Ω}}_{t r} ( j )$$

where, for j=1, . . . , m,

Ωₜᵣ(j)={x∈Ωₜᵣ:y(x)=j}

which is the genuine classification of the elements,

and

\hat{Ω}ₜᵣ(j)={x∈Ωₜᵣ:ŷ(x)=j}

which is the approximate classification of the elements.

Define the cardinalities nₜᵣ=|Ωₜᵣ| and nₜᵣ(j)=|Ωₜᵣ(j)|, and obviously, nₜᵣ=Σⱼ₌₁^{m}nₜᵣ(j). The cardinality |A| of a set A is simply the number of elements in the set A.

(Preliminary Step P5: Preparing a Test Set)

The test set Ωₜₜ is used to determine the accuracy of ŷ, where the accuracy may refer to the percentage (%) of x's in Ωₜₜ such that ŷ(x)=y(x), for example. It is assumed that both Ωₜᵣ and Ωₜₜ are sufficiently large and share the full characteristics represented by the whole data Ω.

(Main Step Q1: Combining Developed Classifiers)

Suppose that there are k developed classifiers, ŷ₁, . . . , ŷₖ, k≥2. A vector function is defined as:

V(x)=(ŷ₁(x), . . . ,ŷₖ(x))∈S^{k},x∈Ω

(Main Step Q2: Creating Buckets with Identities)

As y and ŷ induce partitions of Ωₜᵣ, so does the vector function V. That is:

$${Ω}_{tr} = {⋃}_{I ∈ {S}^{k}} B ( I )$$

where, for any I∈S^{k},

B(I)={x∈Ωₜᵣ:V(x)=I}

Now, I is called an “identity” and B(I) is called a “bucket” in Ωₜᵣ with the identity I. In the following description, when an element x is said distributed to B(I), it means that V(x)=I.

(Main Step Q3: Merging Buckets)

It can be understood that totally there are m^{k} (m to the k-th power) buckets. The plan is to assign a membership to each bucket, instead of each individual element. Certainly, such assignment is determined by the composition of the elements in the bucket. This raises a question: how can it be done if a bucket is empty?Furthermore, buckets having only few elements usually carry poor information, and thus likely lead to incorrect answers. Therefore empty buckets and small buckets with very few elements need to be merged into large buckets. For this purpose, define n_{B(I)}=|B(I)| and n_{B(I)}(j)=|B(I)∩Ωₜᵣ(j)|, and obviously, n_{B(I)}=Σⱼ₌₁^{m}n_{B(I)}(j). In a possible way, a merged bucket B may be obtained in such a way that the condition:

$${max}_{j} \{ \frac{{n}_{B} ( j )}{{n}_{tr} ( j )} \} \geq α$$

holds for certain predetermined positive constant α. The choice of α may be problem dependent A merged bucket will still be denoted as B(I) with I being any one of the identities for which B(I) is part of this merged bucket. Consequently, a merged bucket has more than one way of representation. (For example, when B((1,2,2,3)) and B((1,2,3,3)) are merged into a large bucket, B((1,2,2,3)) is chosen to denote the merged bucket, for the sake of simplifying the representation of the merged bucket. However, it is still possible to choose B((1,2,3,3)) as an alternative representation of the merged bucket.)

(Main Step Q4: Assigning Memberships)

Then, memberships are assigned respectively to the buckets. Such assignment may be done in many ways. One possible approach is illustrated in the following description.

Let a bucket B(I) in Ωₜᵣ with identity I be given. Assign the bucket a membership j if the ratio of the number of elements with membership j in B(I) to |Ωₜᵣ(j)| is maximal among ratios of all memberships. This defines a function Y:{B(I)}→S on the collection of buckets that:

$$Y ( B ( I ) ) = j if {max}_{1 \leq ℓ \leq m} \{ \frac{\vert B ( I ) ⋂ {Ω}_{tr} ( ℓ ) \vert}{\vert {Ω}_{t r} ( ℓ ) \vert} \} = \frac{\vert B ( I ) ⋂ {Ω}_{tr} ( j ) \vert}{\vert {Ω}_{tr} ( j ) \vert}$$

It should be emphasized that there are many ways to determine the membership of a bucket, and which then result in different functions Y.

(Main Step Q5: Configuring an Eclectic Classifier)

The following is then the formal definition of the eclectic classifier \tilde{y}:Ω→S of the present invention:

\tilde{y}(x)=Y(B(V(x))),x∈Ω

In summary, the present invention solves the classification problem as follows: Given any element x∈Ω, apply V on x to obtain its identity I=V(x)∈S^{k}. Accordingly, x is distributed to the bucket B(I) which has the membership Y(B(I)). Finally, the eclectic classifier asserts that Y(B(I)) is also the membership of x. In other words, every element inherits the membership of the bucket to which it is distributed.

Next, according to a second aspect of the present invention, an application of level of confidence (LOC) is introduced associated with the aforementioned membership assignment.

It should be emphasized that LOC is an attribute of each element of Ω with respect to the training set Ωₜᵣ. An LOC can be formulated, computed, and utilized toward a better solution of the classification problem. For each bucket B(I), an LOC with respect to the training set Ωₜᵣ, denoted by μ, is designated to both the bucket and each element distributed to it as follows:

$$μ ( B ( I ) ) = \frac{\vert B ( I ) ⋂ {Ω}_{tr} ( Y ( B ( I ) ) ) \vert}{\vert B ( I ) \vert}$$

$$and$$

$$μ ( x ) = μ ( B ( V ( x ) ) ) , x ∈ Ω$$

With the aforementioned assumption that both Ωₜᵣ and Ωₜₜ are sufficiently large and share the full characteristics represented by the whole data Ω, the application of LOC may be interpreted as follows:

Let B be a non-merged bucket and let T be the set containing all elements in Ωₜₜ which are distributed to B. Then, the accuracy of \tilde{y} on T is approximately equal to the LOC of B. That is to say, the percentage of x's in T for which the equation \tilde{y}(x)=y(x) holds is approximately equal to the LOC of B.

It should be noted that the accuracy of a classifier and the LOC of an element are two different concepts. The former is one of the criteria used to evaluate the performance of a classifier, while the latter is, heuristically, an index of the element describing the effectiveness of membership recognition with respect to the training set.

Other objects, advantages, and novel features of the invention will become more apparent from the following detailed description when taken in conjunction with the accompanying drawings.

### BRIEF DESCRIPTION OF THE DRAWINGS

FIG. 1 shows a schematic diagram of a prior art classifier;

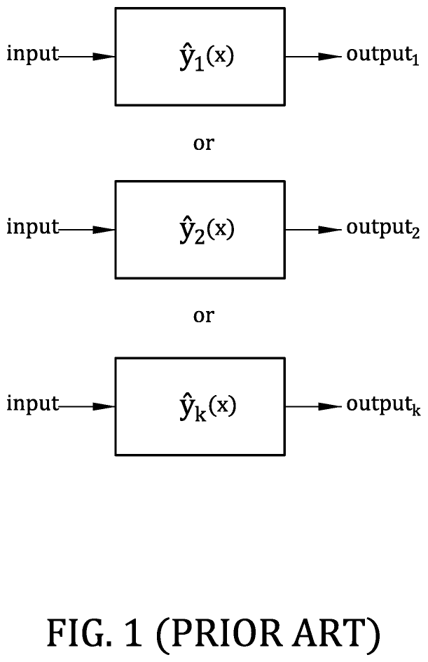

FIG. 2 shows a schematic block diagram of the eclectic classifier according to one embodiment of the present invention; and

FIG. 3 shows a schematic block diagram of the eclectic classifier according to one embodiment of the present invention for prediction or decision.

### DETAILED DESCRIPTION OF THE EMBODIMENT

Different embodiments of the present invention are provided in the following description. These embodiments are meant to explain the technical content of the present invention, but not meant to limit the scope of the present invention. A feature described in an embodiment may be applied to other embodiments by suitable modification, substitution, combination, or separation.

It should be noted that, in the present specification, when a component is described to have an element, it means that the component may have one or more of the elements, and it does not mean that the component has only one of the element, except otherwise specified.

Moreover, in the present specification, the ordinal numbers, such as “first” or “second”, are used to distinguish a plurality of elements having the same name, and it does not means that there is essentially a level, a rank, an executing order, or a manufacturing order among the elements, except otherwise specified. A “first” element and a “second” element may exist together in the same component, or alternatively, they may exist in different components, respectively. The existence of an element described by a greater ordinal number does not essentially mean the existent of another element described by a smaller ordinal number.

Moreover, in the present specification, the terms, such as “preferably” or “advantageously”, are used to describe an optional or additional element or feature, and in other words, the element or the feature is not an essential element, and may be ignored in some embodiments.

Moreover, each component may be realized as a single circuit or an integrated circuit in suitable ways, and may include one or more active elements, such as transistors or logic gates, or one or more passive elements, such as resistors, capacitors, or inductors, but not limited thereto. Each component may be connected to each other in suitable ways, for example, by using one or more traces to form series connection or parallel connection, especially to satisfy the requirements of input terminal and output terminal. Furthermore, each component may allow transmitting or receiving input signals or output signals in sequence or in parallel. The aforementioned configurations may be realized depending on practical applications.

Moreover, in the present specification, the terms, such as “system”, “apparatus”, “device”, “module”, or “unit”, refer to an electronic element, or a digital circuit, an analogous circuit, or other general circuit, composed of a plurality of electronic elements, and there is not essentially a level or a rank among the aforementioned terms, except otherwise specified.

Moreover, in the present specification, two elements may be electrically connected to each other directly or indirectly, except otherwise specified. In an indirect connection, one or more elements may exist between the two elements.

(Eclectic Classifier)

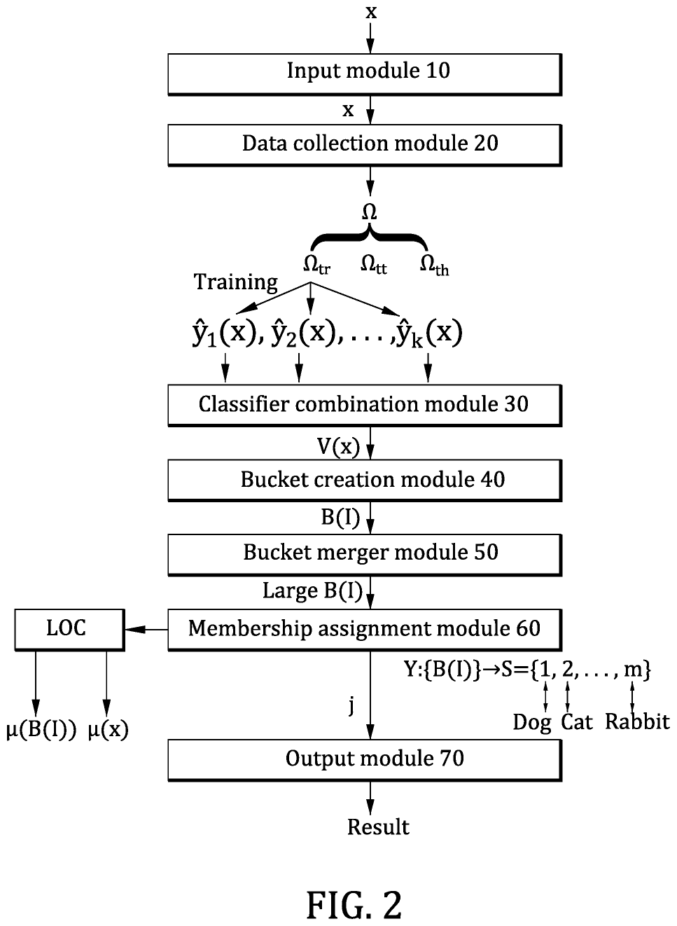

FIG. 2 shows a schematic block diagram of the eclectic classifier 1 according to one embodiment of the present invention.

As shown, the eclectic classifier 1 of the present invention, provided in the context of machine learning, includes an input module 10, a data collection module 20, a classifier combination module 30, a bucket creation module 40, a bucket merger module 50, a membership assignment module 60, and an output module 70.

It can be understood that the modules are illustrated here for the purpose of explaining the present invention, and the modules may be integrated or separated into other forms as hardware or software in separated circuit devices on a set of chips or an integrated circuit device on a single chip. The eclectic classifier 1 is implemented in a cloud server or a local computer.

The input module 10 is configured to receive sample data (or an element) x. The input module 10 may be a sensor, a camera, a speaker, and so on, that can detect physical phenomena, or it may be a data receiver.

The data collection module 20 is connected to the input module 10 and configured to store a collection of data Ω from the input module 10. The collection of data Ω⊂ [symbol] ^{p} includes a training Ωₜᵣ and/or a test set Ωₜₜ and/or a remaining set Ωₜₕ. Here [symbol] is the set of real numbers and the expression Ω⊂ [symbol] ^{p} means that the collection of data Ω belongs to [symbol] ^{p}, the space of p-dimensional real vectors.

With supervised approach, a membership function y:Ω→S={1, 2, . . . , m} can be found so that y(x) gives precisely the membership of the input data x. Accordingly, the collection of data Ω is composed of m memberships (or data categories), and the m memberships are digitized as 1, 2, . . . , m. To specifically explain the meaning of the data categories, for example, when a classifier is used to recognize animal pictures, membership “1” may indicate “dog”, membership “2” may indicate “cat”, . . . , and membership “m” may indicate “rabbit”, herein, “dog”, “cat”, and “rabbit” are regarded as the data categories.

The classifier combination module 30 is connected to the data collection module 20 and configured to combine k developed classifiers ŷ₁, . . . , ŷₖ, k≥2, trained with the training set Ωₜᵣ, wherein k is the number of developed classifiers. Each of the developed classifiers ŷ₁, . . . , ŷₖ may employ one model from convolutional neural network (CNN), recurrent neural network (RNN), long short-term memory (LSTM) network, YOLO, ResNet, ResNet-18, ResNet-34, Vgg16, GoogleNet, Lenet, MobileNet, decision trees, or support vector machine (SVM), but not limited thereto. The developed classifiers ŷ₁, . . . , ŷₖ should be adjusted or trained to have different architectures (regarding the number of neurons, their connections, weights, or bias) even if they employ the same module from the aforementioned models.

However, the developed classifiers ŷ₁, . . . , ŷₖ typically handle the same type of data, for example, they all handle image recognition, all handle sound recognition, and so on.

In particularly, the developed classifiers ŷ₁, . . . , ŷₖ are combined to form a vector function defined as:

V(x)=(ŷ₁(x), . . . ,ŷₖ(x))∈S^{k},x∈Ω

Here, each V(x) is a preliminary result given by the developed classifiers ŷ₁, . . . , ŷₖ, and it is a k-dimensional real vector, and S^{k}={(jᵢ, . . . , jₖ):jᵢ, . . . , jₖ∈S} collects the preliminary results for x∈Ω. The preliminary results will be further processed as follows.

The bucket creation module 40 is connected to the classifier combination module 30 and configured to partition the training set Ωₜᵣ into buckets B(I) with identities I. That is:

$${Ω}_{tr} = {⋃}_{I ∈ {S}^{k}} B ( I )$$

where, for any identity I∈S^{k},

B(I)={x∈Ωₜᵣ:V(x)=I}

When an element x is said distributed to B(I), it means that V(x)=I. The identities I are associated with characteristics of the data.

It can be understood that the buckets are also data sets created to realize the classification according to the present invention. To specifically explain the meaning of the bucket B(I) and its identity I, for example, in case of m=3 and k=4, a possible form of the identity may be I=(1,2,2,3), and a possible form of the bucket may be B(I)=B((1,2,2,3))={x∈Ωₜᵣ; ŷ₁(x)=1, ŷ₂(x)=2, ŷ₃(x)=2, ŷ₄(x)=3}.

The bucket merger module 50 is connected to the bucket creation module 40 and configured to merge empty buckets and/or small buckets into large buckets, for example, according to their cardinalities, so as to reduce the bias caused by the rareness of data therein.

In particular, it is possible to define n_{B}(I)=|B(I)| and n_{B}(I)(j)=|B(I)∩Ωₜᵣ(j)|, and obviously, n_{B}(I)=Σⱼ₌₁^{m}n_{B(I)}(j). The bucket creation module 40 is then further configured to define (or denote) the cardinality n_{B(I)}(j) of a bucket B(I) with a membership j and the cardinality nₜᵣ(j) of a subset of the training set Ωₜᵣ with the membership j, and to perform merger such that

$${max}_{j} \{ \frac{{n}_{B} ( j )}{{n}_{tr} ( j )} \} \geq α$$

holds for certain predetermined positive constant α between 0 and 1. The choice of the constant α may be problem dependent, so a specific value of α will not be given in the present description.

The membership assignment module 60 is indirectly connected to the bucket creation module 40 through the bucket merger module 50 and configured to assign respective memberships j's to the respective buckets B(I), for example, according to their cardinalities. The memberships j's refer to data categories of the training set Ωₜᵣ.

One possible approach is that: let a bucket B(I) in the training set Ωₜᵣ with identity I be given. Assign the bucket B(I) a membership j if the ratio of the number of sample data (or elements) x's with membership j in B(I) to the cardinality |Ωₜᵣ(j)| of a subset Ωₜᵣ(j) of the training set Ωₜᵣ with membership j is maximal among ratios of all memberships. This defines a function Y on the collection of buckets B(I) to S that

$$Y ( B ( I ) ) = j if {max}_{1 \leq ℓ \leq m} \{ \frac{\vert B ( I ) ⋂ {Ω}_{tr} ( ℓ ) \vert}{\vert {Ω}_{t r} ( ℓ ) \vert} \} = \frac{\vert B ( I ) ⋂ {Ω}_{tr} ( j ) \vert}{\vert {Ω}_{tr} ( j ) \vert}$$

It should be emphasized that there are many ways to determine the membership of a bucket, and which then result in different functions Y.

The output module 70 is indirectly connected to the classifier combination module 30 through the bucket creation module 40, the bucket merger module 50, and the membership assignment module 60, and configured to derive an output result after the sample data x is processed through the classifier combination module 30. The output result may be directly the membership j, or converted to the data category, such as “dog”, “cat”, or “rabbit” indicated by the membership.

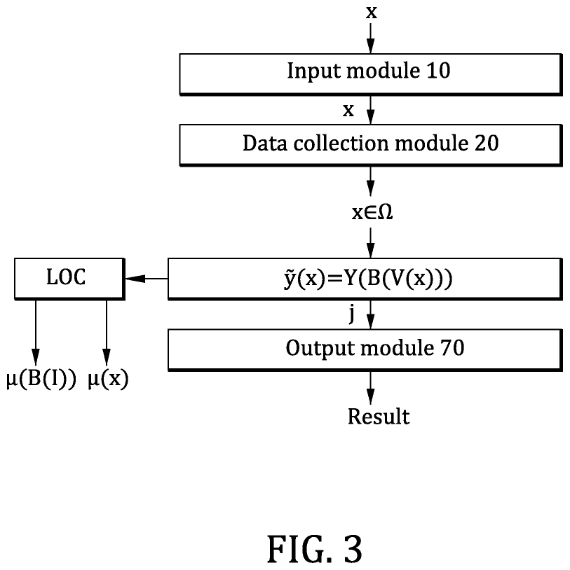

FIG. 3 shows a schematic block diagram of the eclectic classifier according to one embodiment of the present invention for prediction or decision.

The eclectic classifier 1 of the present invention can be expressed by the following formal definition:

\tilde{y}(x)=Y(B(V(x))),x∈Ω

In summary, the present invention solves the classification problem as follows: Given any sample data x∈Ω (Ω may include the training set Ωₜᵣ and/or the test set Ωₜₜ and/or the remaining set Ωₜₕ), apply the vector function V on the sample data x to obtain its identity I=V(x)∈S^{k}. Accordingly, in our words, x is distributed to the bucket B(I) which has the membership Y(B(I)). Naturally, the sample data x receives the same membership of the bucket B(I), namely Y(B(I)).

(Level of Confidence)

With the aforementioned implementation, the eclectic classifier 1 of the present invention can further produce a level of confidence (LOC) associated with the membership assignment module 60, as shown in FIG. 2. The LOC is an attribute of each element of the collection of data Ω with respect to the training set Ωₜᵣ.

For each bucket B(I), an LOC with respect to the training set Ωₜᵣ, denoted by μ, is designated to the bucket B(I) as a ratio of the cardinality of an intersection of the bucket B(I) and Ωₜᵣ(Y(B(I)), a subset of the training set Ωₜᵣ with membership Y(B(I)), to the cardinality of the bucket B(I), that is:

$$μ ( B ( I ) ) = \frac{\vert B ( I ) ⋂ {Ω}_{tr} ( Y ( B ( I ) ) ) \vert}{\vert B ( I ) \vert}$$

This LOC, defined for buckets as given above, is then designated to each sample data x distributed to the bucket B(I). In this way, LOC is defined for every element:

μ(x)=μ(B(V(x))),x∈Ω

(Method to Implement an Eclectic Classifier)

The respective modules and the structure of the eclectic classifier 1 of the present invention have been discussed above. However, in the aspect of software, the eclectic classifier 1 may be implemented by a sequence of steps, as introduced above. Therefore, the method of the present invention essentially includes the following steps, executed in order:

(a) preparing a training set Ωₜᵣ from a collection of data Ω. Preferably, the training set Ωₜᵣ is further decomposed into subsets Ωₜᵣ(j). This step may be executed by the aforementioned data collection module 20.

(b) training k developed classifiers ŷ₁, . . . , ŷₖ, k≥2, with the training set (Ωₜᵣ). The classifiers ŷ₁, . . . , ŷₖ may be trained individually by conventional approaches.

(c) combining the developed classifiers ŷ₁, . . . , ŷₖ to form a vector function V(x)=(ŷ₁(x), . . . , ŷₖ(x)). This step may be executed by the aforementioned classifier combination module 30.

(d) creating buckets B(I) with identities I, wherein when sample data x is said distributed to a bucket B(I), it means that V(x)=I. This step may be executed by the aforementioned bucket creation module 40.

(e) merging empty buckets and/or small buckets into large buckets. This step may be executed by the aforementioned bucket merger module 50.

(f) assigning memberships j's respectively to the buckets, the memberships j's referring to data categories of the training set Ωₜᵣ. This step may be executed by the aforementioned membership assignment module 60.

(g) deriving an output result \tilde{y}(x) (its data category) after sample data x is processed through the vector function V(x). This step may be executed by the aforementioned output module 70.

In conclusion, the present invention provides an eclectic classifier, which combines the results from several developed classifiers that can give a maximal ratio or a majority of predictions or decisions regarded as an optimal answer. In this way, the extreme influences of the disadvantages of the developed classifiers can be avoided, and the advantages of the developed classifiers can be jointly taken into consideration.

Although the present invention has been explained in relation to its preferred embodiment, it is to be understood that many other possible modifications and variations can be made without departing from the spirit and scope of the invention as hereinafter claimed.

What is claimed is:

1. An eclectic classifier, comprising:
an input module configured to receive sample data (x);
a data collection module connected to the input module and configured to store a collection of data (Ω) from the input module, the collection of data (Ω) including a training set (Ωₜᵣ) and/or a test set (Ωₜₜ);
a classifier combination module connected to the data collection module and configured to combine k developed classifiers (ŷ₁, . . . , ŷₖ), k≥2, the developed classifiers (ŷ₁, . . . , ŷₖ) being trained with the training set (Ωₜᵣ); and
an output module connected to the classifier combination module and configured to derive an output result after the sample data (x) is processed through the classifier combination module.

2. The eclectic classifier of claim 1, wherein the developed classifiers (ŷ₁, . . . , ŷₖ) are combined to form a vector function V(x)=(ŷ₁(x), . . . , ŷₖ(X)), wherein an outcome of the vector function V, which is a k-dimensional vector, is denoted by I.

3. The eclectic classifier of claim 2, further comprising a bucket creation module connected to the classifier combination module and configured to partition the training set (Ωₜᵣ) into a disjoint union of subsets, which are called buckets and denoted by B(I).

4. The eclectic classifier of claim 3, wherein the respective buckets (B(I)) have respective identities (I) associated with characteristics of the data.

5. The eclectic classifier of claim 3, further comprising a bucket merger module connected to the bucket creation module and configured to merge empty buckets and/or small buckets into large buckets.

6. The eclectic classifier of claim 5, wherein the bucket creation module is further configured to merge the empty buckets and/or the small buckets according to their cardinalities.

7. The eclectic classifier of claim 6, wherein the bucket creation module is further configured to denote the cardinality of a subset of the bucket (B(I)) with membership (j) by (n_{B(I)}(j)) and the cardinality of a subset of the training set (Ωₜᵣ) with membership (j) by (nₜᵣ(j)), and to perform merger such that the merged bucket (B) is sufficiently large that the condition
$${max}_{j} \{ \frac{{n}_{B} ( j )}{{n}_{tr} ( j )} \} \geq α$$
holds for a certain predetermined positive constant (α).

8. The eclectic classifier of claim 7, further comprising a membership assignment module connected to the bucket creation module and configured to assign respective memberships (j's) to the respective buckets (B(I)), the memberships (j's) referring to data categories of the training set (Ωₜᵣ); wherein in this assignment, Y(B(I))=j.

9. The eclectic classifier of claim 8, wherein the memberships (j's) are assigned to the respective buckets (B(I)) according to their cardinalities.

10. The eclectic classifier of claim 9, wherein the memberships (j's) are assigned to the respective buckets (B(I)) if a ratio of the cardinality of sample data (x) with the membership (j) in a bucket (B(I)) to the cardinality of a subset (Ωₜᵣ)) of the training set (Ωₜᵣ) with the membership (j) is maximal among ratios of all memberships.

11. The eclectic classifier of claim 10, wherein the membership of sample data (x) in the collection of data (Ω) is also the membership of the bucket (B(I)) to which the sample data (x) is distributed.

12. The eclectic classifier of claim 8, wherein the eclectic classifier is configured to produce a level of confidence (LOC) associated with the membership assignment module, the LOC being an attribute of each element of the collection of data (Ω) with respect to the training set (Ωₜᵣ).

13. The eclectic classifier of claim 12, wherein the LOC is designated to the bucket (B(I)) as a ratio of the cardinality of an intersection of the bucket (B(I)) and (Ωₜᵣ(Y(B(I))), a subset of the training set (Ωₜᵣ) with membership Y(B(I)), to the cardinality of the bucket (B(I)).

14. The eclectic classifier of claim 12, wherein the LOC defined for the bucket (B(I)) is designated to each sample data (x) distributed to the bucket (B(I)).

15. The eclectic classifier of claim 1, wherein the eclectic classifier is implemented in a cloud server or a local computer as hardware or software or as separated circuit devices on a set of chips or an integrated circuit device on a single chip.

16. A method to implement an eclectic classifier, comprising following steps:
preparing a training set (Ωₜᵣ) from a collection of data (Ω);
training k developed classifiers (ŷ₁, . . . , ŷₖ, k≥2, with the training set (Ωₜᵣ);
combining the developed classifiers (ŷ¹, . . . , ŷₖ) to form a vector function V(x)=(ŷ₁(x), . . . , ŷₖ(x)); and
deriving an output result after sample data (x) is processed through the vector function V(x).

17. The method of claim 16, further comprising a step of decomposing the training set (Ωₜᵣ) into subsets (Ωₜᵣ(j)).

18. The method of claim 17, further comprising a step of creating buckets (B(I)) with identities (I), wherein when sample data (x) is said distributed to a bucket (B(I)), it means that V(x)=I.

19. The method of claim 18, further comprising a step of merging empty buckets and/or small buckets into large buckets.

20. The method of claim 19, further comprising a step of assigning memberships (j's) respectively to the buckets, the memberships (j's) referring to data categories of the training set (Ωₜᵣ).
